(19) United States
(12) Patent Application Publication
(10) Pub. No.: US 2011/0208486 A1
(43) Pub. Date: Aug. 25, 2011

(54) COMPUTER BASED MODELING OF FIBROUS MATERIALS

(76) Inventors: Khalid QURESHI, Mason, OH (US); Michael Timothy Looney, West Chester, OH (US); Olaf Erik Alexander Isele, West Chester, OH (US); Amber Diane Fischer, Honolulu, HI (US)

(21) Appl. No.: 13/029,154

(22) Filed: Feb. 17, 2011

Related U.S. Application Data
(60) Provisional application No. 61/306,180, filed on Feb. 19, 2010.

(51) Int. Cl. G06F 17/50

(52) U.S. Cl. 703/1

(57) ABSTRACT

Computer based models of fibrous materials.

### CROSS-REFERENCE TO RELATED APPLICATION

This application claims priority to U.S. provisional application 61/306,180, filed Feb. 19, 2010, which is hereby incorporated by reference.

### FIELD

In general, embodiments of the present disclosure relate to fibrous materials. In particular, embodiments of the present disclosure relate to methods of modeling fibrous materials.

### BACKGROUND

A fibrous material is a structure of many fibers. To make a fibrous material, fibers are joined together to form a web. In making a fibrous web, each fiber is laid down in a particular location along a curvilinear path that has an overall orientation. The location, curliness, and orientation occur randomly, within certain probabilities. It can be difficult to model this combination of randomness and probability for a fiber's location, curliness, and orientation. As a result, it can be difficult to create a realistic model of a fibrous material.

### SUMMARY

However, the present disclosure provides methods for modeling a fibrous web. The methods can predict a fiber's location, curliness, and orientation, while accounting for randomness and probabilities. The methods can be used to create a realistic model of a fibrous material. As a result, fibrous materials can be evaluated and modified as computer based models before they are tested as real world things.

### BRIEF DESCRIPTION OF THE DRAWINGS

FIG. 1 illustrates a method of creating a computer based model of a fiber.

FIG. 2A illustrates a first probability distribution of angles.

FIG. 2B illustrates a second probability distribution of angles.

FIGS. 3A-3F illustrates embodiments of a computer based model of a fiber.

FIG. 4 illustrates a method of creating a computer based model of a fibrous material.

FIGS. 5A-5H illustrates embodiments of a computer based modeling environment for use in a method of creating a computer based model of a fibrous material.

### DETAILED DESCRIPTION

The present disclosure provides methods for modeling a fibrous web. The methods can predict a fiber's location, curliness, and orientation, while accounting for randomness and probabilities. The methods can be used to create a realistic model of a fibrous material. As a result, fibrous materials can be evaluated and modified as computer based models before they are tested as real world things.

The methods of the present disclosure can be used to create realistic models of various fibrous materials. Fibrous materials can be made from animal fibers, plant fibers, mineral fibers, synthetic fibers, etc. Fibrous materials can include short fibers, long fibers, continuous fibers, fibers of varying lengths or cross-sectional geometries, or combinations of any of these. In some cases, a fibrous material can include another material, can be joined to another material, or can be incorporated into another material. Fibrous materials can take many forms, such as fabrics, textiles, and composites. Examples of fabrics include fibrous textiles (woven or knitted fabrics), felts, nonwovens, papers, and others. Examples of fibrous composites include composite materials with polymeric fibers, carbon fibers, glass fibers, and metal fibers, to name a few. Throughout the present disclosure, nonwoven materials are used to describe and illustrate various embodiments. However, it is contemplated that embodiments of the present disclosure are not limited to nonwoven materials, but can be similarly applied to a wide variety of fibrous materials, such as those described above, as will be understood by one of skill in the art.

As an example, methods of the present disclosure can be used to create realistic models of fibrous nonwoven materials. The term “nonwoven material” refers to a sheet-like structure (e.g. web) of fibers (sometimes referred to as filaments) that are interlaid in a non-uniform, irregular, or random manner. A nonwoven material can be a single layer structure or a multiple layer structure. A nonwoven material can also be joined to another material, such as a film, to form a laminate.

A nonwoven material can be made from various natural and/or synthetic materials. Exemplary natural materials include cellulosic fibers, such as cotton, jute, pulp, and the like; and also can include reprocessed cellulosic fibers like rayon or viscose. Natural fibers for a nonwoven material can be prepared using various processes such as carding, etc. Exemplary synthetic materials include but are not limited to synthetic thermoplastic polymers that are known to form fibers, which include, but are not limited to, polyolefins, e.g., polyethylene, polypropylene, polybutylene and the like; polyamides, e.g., nylon 6, nylon 6/6, nylon 10, nylon 12 and the like; polyesters, e.g., polyethylene terephthalate, polybutylene terephthalate, polylactic acid and the like; polycarbonate; polystyrene; thermoplastic elastomers; vinyl polymers; polyurethane; and blends and copolymers thereof.

Fibers of a relatively short length, e.g. 40 mm or less, are typically manufactured into a nonwoven using processes like drylaying, e.g. carding or airlaying, or wetlaying (including paper). Continuous fibers or filaments can be spun out of molten thermoplastics or chemical solutions and formed into a web using spunlaying/spunbonding, meltblowing, or electrospinning by example. Other means of forming a nonwoven is by film fibrillation. These processes can also be combined to form composite or layered fabric structures.

The methods of the present disclosure can be implemented by using Computer Aided Engineering (CAE). CAE is a broad area of applied science in which technologists use software to develop computer based models that represent real world things. The models can be transformed to provide various information about the physical behavior of those real world things, under certain conditions and/or over particular periods of time. As an example, CAE can be used to design, create, simulate, and/or evaluate models of all kinds of fibrous materials, their features, structures, and compositions, as well as their performance characteristics, such as their tensile strengths and neckdown modulii.

There are several major categories of CAE, including Finite Element Analysis (FEA). In FEA, models representing mechanical articles, as well as their features, components, structures, and/or materials are transformed to predict stress, strain, displacement, deformation, and other mechanical behaviors. FEA represents a continuous solid material as a set of discrete elements. In FEA, the mechanical behavior of each element is calculated, using equations that describe mechanical behavior. The results of all of the elements are summed up, to represent the mechanical behavior of the material as a whole.

Commercially available software can be used to conduct CAE. Abaqus, from SIMULIA in Providence, R.I., and LSDyna from Livermore Software Technology Corp. in Livermore, Calif., are examples of commercially available FEA software. Alternatively, CAE software can be written as custom software. CAE software can be run on various computer hardware, such as a personal computer, a minicomputer, a cluster of computers, a mainframe, a supercomputer, or any other kind of machine on which program instructions can execute to perform CAE functions.

CAE software can represent a number of real world things, such as fibrous materials. CAE software can also represent articles that incorporate fibrous materials, such as absorbent articles. An absorbent article can receive, contain, and absorb bodily exudates (e.g. urine, menses, feces, etc.). Absorbent articles include products for sanitary protection, for hygienic use, and the like. Some absorbent articles are wearable. A wearable absorbent article is configured to be worn on or around a lower torso of a body of a wearer. Examples of wearable absorbent articles include diapers and incontinence undergarments.

Some absorbent articles are disposable. A disposable absorbent article is configured to be disposed of after a single use (e.g., not intended to be reused, restored, or laundered). Examples of disposable absorbent articles include disposable diapers, disposable incontinence undergarments, as well as feminine care pads and liners. Some absorbent articles are reusable. A reusable absorbent article is configured to be partly or wholly used more than once. In some embodiments, a reusable absorbent article may be configured such that part or all of the absorbent article is wear-resistant to laundering or fully launderable. An example of a reusable absorbent article is a diaper with a washable outer cover. In other embodiments, a reusable absorbent article may not be configured to be launderable.

CAE software can also represent other articles that incorporate fibrous materials, including wipes, diaper wipes, body wipes, toilet tissue, facial tissue, wound dressings, handkerchiefs, household wipes, window wipes, bathroom wipes, surface wipes, countertop wipes, floor wipes, and other articles, as will be understood by one of skill in the art.

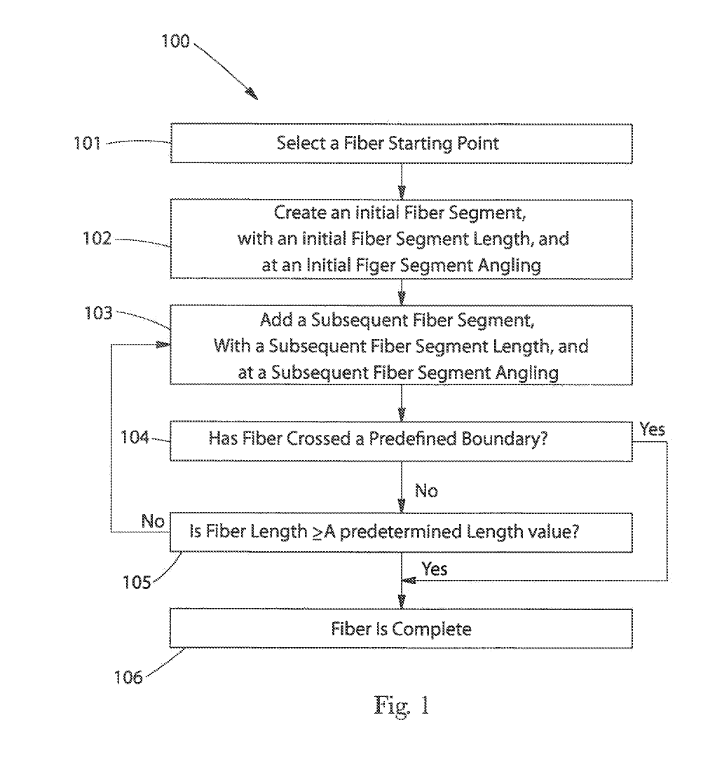

FIG. 1 illustrates a method 100 of creating a computer based model of a fiber. Although the steps 101-106 are described in numerical order in the present disclosure, in various embodiments some or all of these steps can be performed in other orders, and/or at overlapping times, and/or at the same time, as will be understood by one of ordinary skill in the art. Program instructions in CAE software (and/or other software) can execute to perform each step in the method 100, as described below.

The method 100 includes a first step 101 of selecting a starting point for the model of the fiber to be created. A fiber starting point is a particular position in a computer based modeling environment, used to locate the fiber. In the method 100, the fiber starting point is a position randomly selected from within a target area, as described herein. In various alternate embodiments, a fiber starting point may be located at a predetermined position or at a position that is not randomly selected. Also, in various embodiments, a fiber starting point may be located within an excess area or outside of an excess area, as described herein. Program instructions can execute to determine a fiber starting point within a computer based modeling environment, as described above.

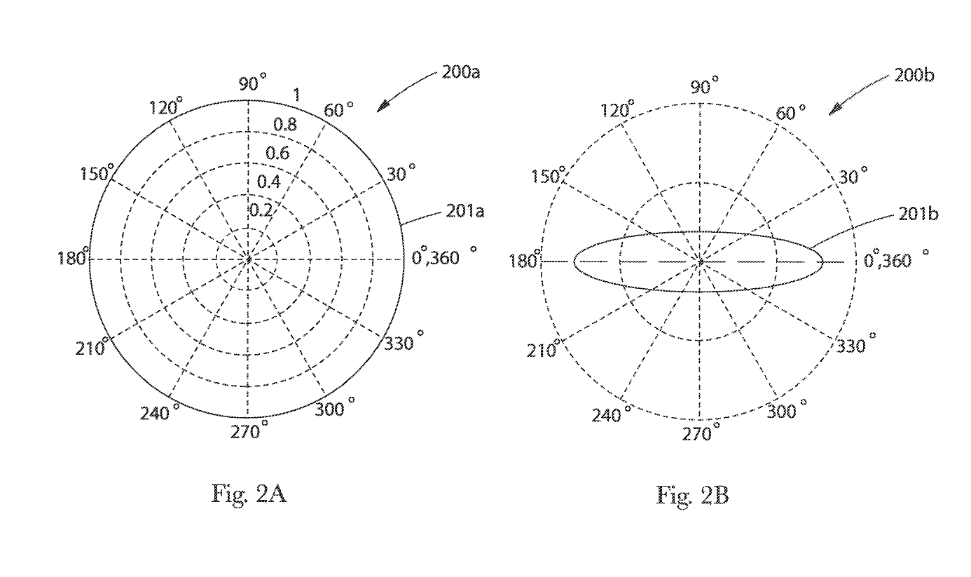

The method 100 includes a second step 102 of creating an initial fiber segment for the model of the fiber. The initial fiber segment is the first fiber segment created in the model of the fiber. A first end of the initial fiber segment is disposed at the fiber starting point from the first step 101. The initial fiber segment has an initial fiber segment length. The initial fiber segment length is less than or equal to a particular upper length value. The upper length value can be determined by a user, to limit the size of each fiber segment. The initial fiber segment is angled, with respect to a chosen reference direction (such as a machine direction), at an initial fiber segment angling. The initial fiber segment angling is based, at least in part, on an initial angle orientation factor, which is provided by the user. The initial angle orientation factor can be used to determine a probability distribution of angles, from which an angle can be randomly selected, as described in connection with the embodiments of FIGS. 2A and 2B. In various embodiments, an initial fiber segment can also be created in other ways. Program instructions can execute to create an initial fiber segment for a model of a fiber, as described above.

The method 100 includes a third step 103 of adding a subsequent fiber segment to the model of the fiber. The subsequent fiber segments are the segments that are added to the model of the fiber after the initial fiber segment is created in the second step 102. A first end of each subsequent fiber segment is connected to an end of an existing fiber segment. The subsequent fiber segment has a subsequent fiber segment length that is less than or equal to the particular upper length value, as described above. The subsequent fiber segment is angled, with respect to a reference direction (such as a machine direction), at a subsequent fiber segment angling. The subsequent fiber segment angling is based, at least in part, on: 1) an angle orientation factor, which is provided by the user, 2) a curl factor, which is provided by the user, and/or 3) the angle of the previous fiber segment.

The angle orientation factor is a scaling factor which can determine the degree to which a subsequent fiber segment is angled toward a particular orientation, such as the machine direction. As contemplated herein, a larger angle orientation factor can bias the subsequent fiber segment angling to a greater degree toward the particular orientation while a smaller orientation factor can bias the subsequent fiber segment angling to a lesser degree toward the particular orientation. However, this particular scheme is not required, and other kinds of factoring can be used.

The curl factor is another scaling factor which can determine the degree to which a subsequent fiber segment angling can vary with respect to the angle of a previous fiber segment. As contemplated herein, a larger curl factor can allow the subsequent fiber segment to be angled at a larger relative angle with respect to the previous fiber segment while a smaller curl factor can allow the subsequent fiber segment to be angled at a smaller relative angle with respect to the previous fiber segment. However, this particular scheme is not required, and other kinds of factoring can be used. In some embodiments, at least some, or substantially all, or even all of the fiber segments in a model of a fiber can be angled at a relative angle of zero with respect to previous fiber segments. In other words, part or all of one or more fibers can be modeled as a straight fiber without curl.

As an example, subsequent fiber angling can be based on a function such as:

Θ_{subsequent}=Θₚᵣₑᵥᵢₒᵤₛ+ΔΘ_{subsequent}

where

ΔΘ_{subsequent}=(ΔΘₚᵣₑᵥᵢₒᵤₛ*0.8)+(random number*Curl Factor*0.33)−(θₚᵣₑᵥᵢₒᵤₛ*0.1*Angle Orientation Factor).

Other subsequent fiber segment angling functions can also be used to obtain subsequent fiber angling, as will be understood by one of ordinary skill in the art. Program instructions can execute to create subsequent fiber segments for a model of a fiber, as described above.

The method 100 includes a fourth step 104 of determining whether the model of the fiber has crossed a predefined boundary. In one embodiment, the predefined boundary can be the excess boundary. In another embodiment, the predefined boundary can be the target boundary. In other embodiments, the predefined boundary can be some other boundary. If the fiber has not reached the predefined boundary, then the method 100 proceeds to repeat the third step 103. If the fiber has reached the predefined boundary, then the method 100 proceeds to the fifth step 105. In various embodiments, the fourth step may be omitted. Program instructions can execute to determine whether a model of a fiber has crossed a predefined boundary, as described above.

The method 100 includes a fifth step 105 of determining whether the length of the model of the fiber has reached a predetermined length value. In one embodiment, the length of the fiber has reached a predetermined value when it reaches half of a predetermined length known for the kind of fiber being modeled. For example, the predetermined length can be a staple length for a fiber. In this embodiment, once this length has been reached, the other half of the fiber can be created by repeating steps 103 to 105 from the first end of the initial fiber segment. In other embodiments, the predetermined length value may be set to another value. If the length of the fiber has not reached the predetermined length value, then the method 100 proceeds to repeat the third step 103. If the length of the fiber has reached the predetermined length value, then the method 100 proceeds to the sixth step 106. In various embodiments, the fifth step may be omitted. Program instructions can execute to determine whether a model of a fiber has reached a predetermined length value, as described above.

The method 100 includes a sixth step 106, which marks the end of the method 100 and the completion of the model of the fiber.

FIG. 2A illustrates a first probability distribution of angles on a polar plot 200a. The polar plot 200a provides a full range of potential initial fiber segment orientation angles, from 0 to 360 degrees. The probability distribution is determined by an elliptical distribution function. In the embodiment of FIG. 2A, the distribution is illustrated by the bold line that defines an ellipse 201a that is concentric with the outer edge of the polar plot 200a. In FIG. 2A, an initial angle orientation factor is set such that the resulting ellipse 201a is circular. In other words, a random selection within the circular elliptical distribution has a probability of falling anywhere within the polar plot 200a. A random sampling within the distribution will result in angles that are not biased toward any particular orientation.

FIG. 2B illustrates a second probability distribution of angles on a polar plot 200b. The polar plot 200b provides a full range of potential initial fiber segment orientation angles, from 0 to 360 degrees. The probability distribution is also determined by an elliptical distribution function. In the embodiment of FIG. 2B, the distribution is illustrated by the bold line that defines an ellipse 201b that is centered within the area of the polar plot 200b. In FIG. 2B, an initial angle orientation factor is set such that the resulting ellipse 201b is elongated, with a major axis that is substantially longer than a minor axis. In other words, a random selection within the elongated elliptical distribution has a probability of falling anywhere within a small defined portion of the polar plot 200b. A random sampling within the distribution will result in angles that are biased toward 0 degrees and toward 180 degrees.

The initial angle orientation factor can be determined by a user, to provide a realistic bias in the initial angling of fiber segments. The bias can be used to realistically represent a fiber laydown process which tends to orient more fibers in a particular orientation, such as the machine direction.

Various elliptical distribution functions can be used to obtain a probability distribution of angles. For example:

$$f ( θ ) = {( \frac{{( a / b )}^{2}}{{cos}^{2} ( θ ) + {( a / b * sin ( θ ) )}^{2}} )}^{1 / 2}$$

where a/b is calculated based on the initial angle orientation factor (IAOF), as follows:

$$a / b = 35.4 * ( 0.163975 - 0.0987193 * {( \frac{4.7967 - IAOF}{1 + IAOF} )}^{1 / 2} )$$

In the exemplary elliptical distribution function provided above, an initial angle orientation factor can range from 0 to 4.7967. In this example, an initial angle orientation factor of 1 results in a circular elliptical distribution as illustrated in FIG. 2A, and an initial angle orientation factor of 3.6 results in an elongated elliptical distribution as illustrated in FIG. 2B. Other distribution functions, both elliptical and non-elliptical, can also be used to obtain probability distribution of angles, as will be understood by one of ordinary skill in the art. In various embodiments, a distribution function and/or an initial angle orientation factor can be chosen to represent directional properties of a real world material. For example, a distribution function and/or an initial angle orientation factor can be chosen to represent a fibrous material with a particular ratio of machine direction stiffness to cross directional stiffness. Program instructions can execute to define a probability distribution of angles and to select angles from within that distribution, as described above.

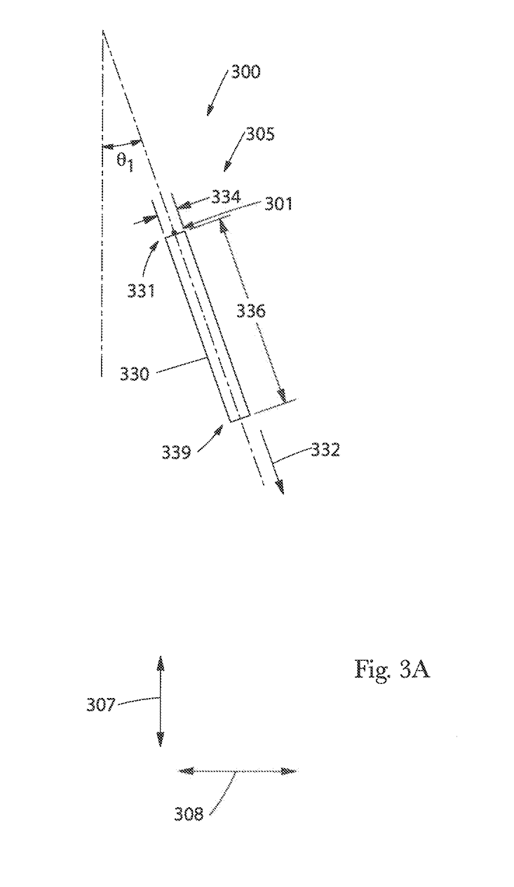

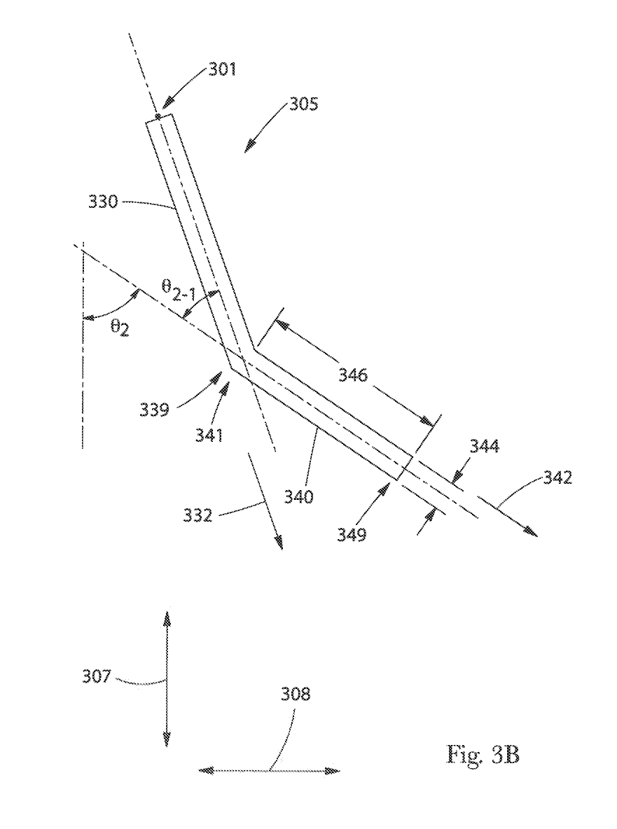

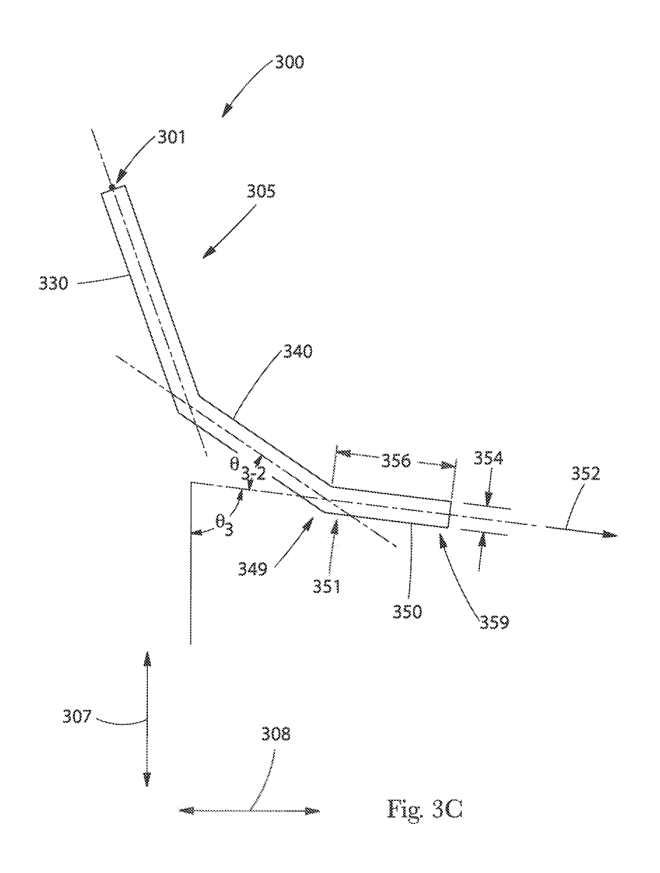

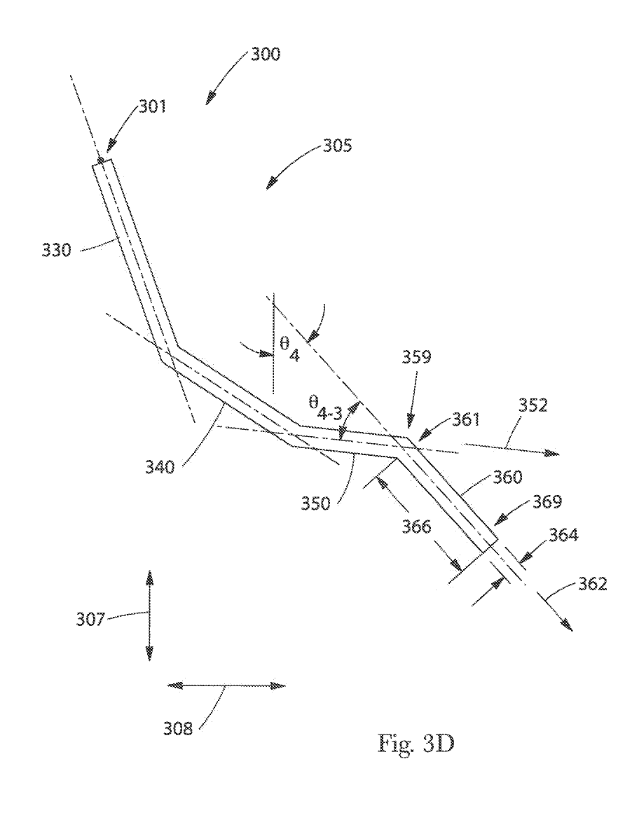

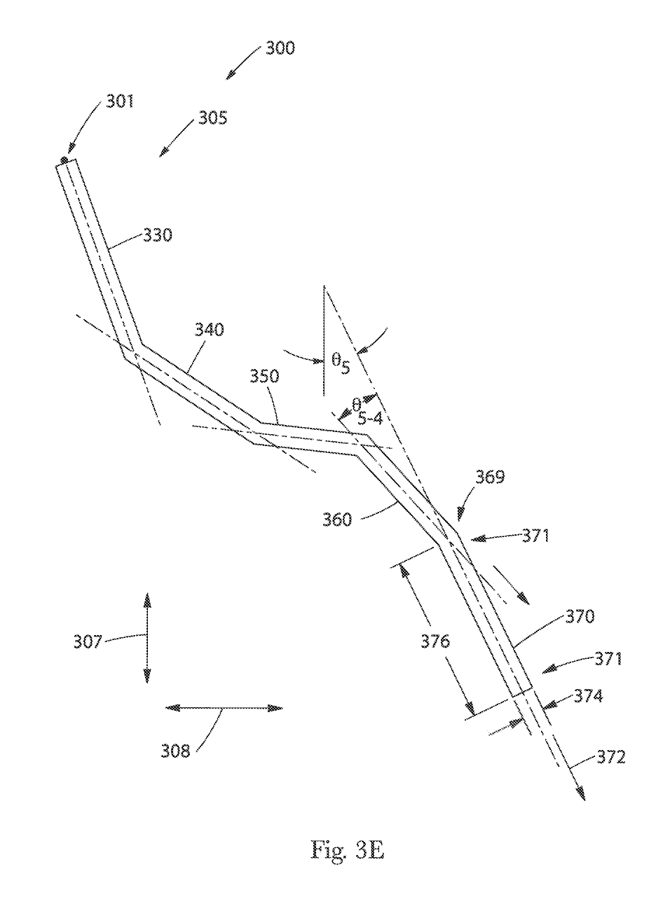

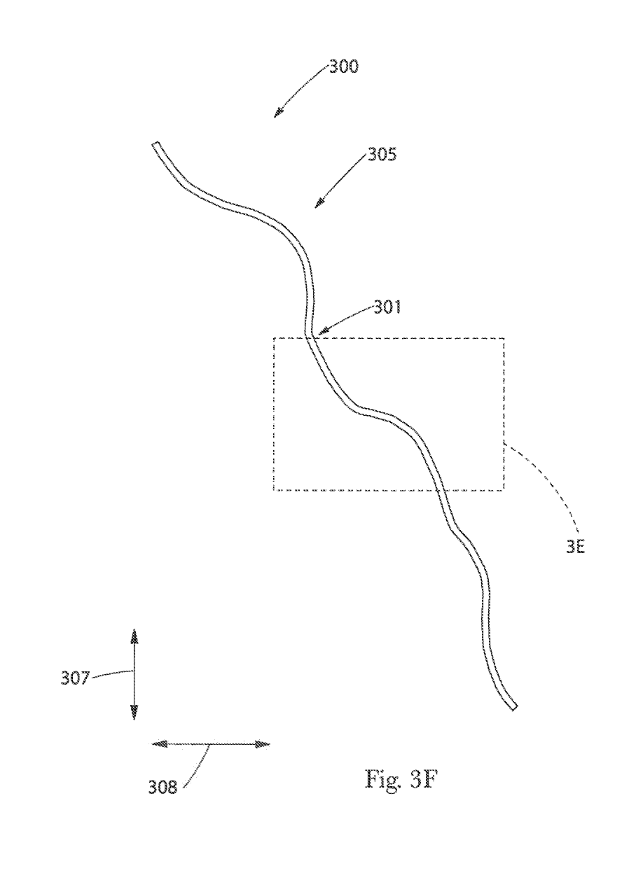

FIGS. 3A-3F illustrates an enlarged top view of computer based model 300 of an exemplary fiber 305. The model 300 of the fiber 305 is formed according to the method 100 of creating a computer based model of a fiber of the embodiment of FIG. 1. The model 305 can be used to simulate any kind of fiber, made from any kind of fiber material, using any kind of fiber laydown process, as disclosed herein or as known in the art.

FIG. 3A illustrates an enlarged top view of a computer based model 300 of a fiber 305 having an initial fiber segment 330. For reference, FIG. 3A includes a machine direction 307 and a cross direction 308. The initial fiber segment 330 follows a linear path, and has a first end 331 and a second end 339. Each fiber segment in the model 300 of the fiber 305 follows a linear path, however, this is not required and, in some embodiments, a fiber segment can follow a curved pathway.

While not shown in FIG. 3A, the initial fiber segment 330 has a uniform circular cross-section. Each fiber segment in the model 300 of the fiber 305 also has a uniform circular cross-section; however, this is not required. In some embodiments, a fiber segment can have a cross-section that varies along the length of the fiber segment. In various embodiments, a fiber segment can have a cross-section with a different overall shape, such as oval, flat, tri-lobal, multi-lobal, etc.

The first end 331 is disposed at a fiber starting point 301, which is selected as described in step 101 of the method 100 of FIG. 1. The initial fiber segment 330 has an overall length 336 between the first end 331 and the second end 339. The overall length 336 is an initial fiber segment length, and is determined as described in step 102 of the method 100 of FIG. 1. The initial fiber segment 330 also has an overall width 334, which can be selected to represent the size of the fiber to be modeled. The initial fiber segment 330 is oriented at an initial angling, in a first direction 332, which is at a first absolute angle of Θ₁ with respect to the machine direction 307. The initial angling is determined as described in step 102 of the method 100 of FIG. 1. The first absolute angle Θ₁ is a small positive angle with respect to the machine direction 307, such that the first direction 332 is oriented substantially in the machine direction 307.

The computer based model 300 of the unbonded fiber 305 can be created as described below, with general references to a computer based model of a fiber. A computer based model that represents a fiber can be created by providing dimensions and material properties to modeling software and by generating a mesh for the article using meshing software.

A computer based model of a fiber can be created with dimensions that are similar to or the same as dimensions that represent a real world fiber. These dimensions can be determined by measuring actual samples, by using known values, or by estimating values. Alternatively, a model of a fiber can be configured with dimensions that do not represent a real world fiber. For example, a model of a fiber can represent a new variation of a fiber or can represent an entirely new fiber. In these examples, dimensions for the model can be determined by varying actual or known values, by estimating values, or by generating new values. The model can be created by putting values for the dimensions of parts of the fiber into the modeling software.

The computer based model of the fiber can be created with material properties that are similar to or the same as material properties that represent a real world fiber. These material properties can be determined by measuring actual samples, by using known values, or by estimating values. Alternatively, a model of a fiber can be configured with material properties that do not represent a real world fiber. For example, a model of a fiber can represent a new variation of a real world fiber or can represent an entirely new fiber. In these examples, material properties for the model can be determined by varying actual or known values, by estimating values, or by generating new values.

The computer based model of the fiber can be created with a mesh for the parts of the fiber. A mesh is a collection of small, connected geometric shapes that define the set of discrete elements in a CAE computer based model. The type of mesh and/or the size of elements can be controlled with user inputs into the meshing software, as will be understood by one of ordinary skill in the art. As examples, a segment of a fiber can be represented by using one or more beam elements, truss elements, other kinds of elements, or combinations of any of these. Each computer based model of a fiber segment or a fiber, in the present disclosure, can be created in these ways.

FIG. 3B illustrates an enlarged top view of the model 300 of FIG. 3A wherein the fiber 305 has an additional segment, which is the second fiber segment 340. Since the second fiber segment 340 is added to the model 300 of the fiber 305 after the initial fiber segment 330 is created, the second fiber segment 340 is considered a subsequent fiber segment. Further, each fiber segment added after the initial fiber segment is created is considered a subsequent fiber segment. For reference, FIG. 3B includes the machine direction 307 and the cross direction 308.

The second fiber segment 340 follows a linear path, and has a first end 341 and a second end 349. The first end 341 is disposed at the second end 339 of the initial fiber segment 330, so that the second fiber segment 340 is connected to the initial fiber segment 330, end to end. In the embodiment of FIG. 3, each subsequent fiber segment is added to an end of a previously created fiber segment. In this way, the model 300 of the fiber 305 is formed by a series of connected fiber segments.

The second fiber segment 340 has an overall length 346 between the first end 341 and the second end 349. The overall length 346 is a subsequent fiber segment length, and is determined as described in step 103 of the method 100 of FIG. 1. In the embodiment of FIG. 3, the overall length of each subsequent fiber segment is a subsequent fiber length, determined as described in step 103 of the method 100 of FIG. 1.

The second fiber segment 340 also has an overall width 344. The overall width 344 is the same as the overall width 334. In the embodiment of FIG. 3, the overall width of each subsequent fiber segment is the same as the overall width of the initial fiber segment; however, this is not required and, in some embodiments, the overall width of the model of the fiber can vary along its length.

The second fiber segment 340 is oriented in a second direction 349, which is at a second absolute angle of Θ₂ with respect to the machine direction 307, and a second relative angle of Θ₂₋₁ with respect to the first direction 332. The angling of the second fiber segment 340 is determined as described in step 102 of the method 100 of FIG. 1. In the embodiment of FIG. 3, the angling of each subsequent fiber segment is determined as described in step 102 of the method 100 of FIG. 1.

The second absolute angle Θ₂ is a positive angle with respect to the machine direction 307. However, any of the absolute angles can be positive or negative. The second absolute angle Θ₂ orients the second fiber segment 340 in the second direction 342, which has a machine direction 307 component and a cross direction 308 component. The second absolute angle Θ₂ is greater than the first absolute angle Θ₁, such that the second relative angle Θ₂₋₁ is a positive angle. However, any of the relative angles can be positive or negative. Due to the second relative angle Θ₂₋₁, the first fiber segment 330 and the second fiber segment 340, taken together, tend to simulate a curl in the fiber 305, away from the machine direction 307.

FIG. 3C illustrates an enlarged top view of the model 300 of FIG. 3B wherein the fiber 305 has an additional segment, which is the third fiber segment 350. The third fiber segment 350 is considered a subsequent fiber segment. For reference, FIG. 3C includes the machine direction 307 and the cross direction 308. The third fiber segment 350 has a first end 351 and a second end 359. The first end 351 is disposed at the second end 349 of the second fiber segment 340, so that the third fiber segment 350 is connected to the second fiber segment 340, end to end. The third fiber segment 350 has an overall length 356 and an overall width 354. The third fiber segment 350 is oriented in a third direction 352, which is at an angle of Θ₃ with respect to the machine direction 307, and at an angle of Θ₃₋₂ with respect to the second direction 342.

The third absolute angle Θ₃ is a large positive angle with respect to the machine direction 307. The third absolute angle Θ₃ orients the third fiber segment 350 in the third direction 352, which is substantially in the cross direction 308. The third absolute angle Θ₃ is greater than the second absolute angle Θ₂, such that the third relative angle Θ₃₋₂ is a positive angle. Due to the third relative angle Θ₃₋₂, the second fiber segment 340 and the third fiber segment 350, taken together, tend to simulate a further curl in the fiber 305, away from the machine direction 307.

FIG. 3D illustrates an enlarged top view of the model 300 of FIG. 3C wherein the fiber 305 has an additional segment, which is the fourth fiber segment 360. The fourth fiber segment 360 is considered a subsequent fiber segment. For reference, FIG. 3D includes the machine direction 307 and the cross direction 308. The fourth fiber segment 360 has a first end 361 and a second end 369. The first end 361 is disposed at the second end 359 of the third fiber segment 350, so that the fourth fiber segment 360 is connected to the third fiber segment 350, end to end. The fourth fiber segment 360 has an overall length 366 and an overall width 364. The fourth fiber segment 360 is oriented in a fourth direction 362, which is at an angle of Θ₄ with respect to the machine direction 307, and at an angle of Θ₄₋₃ with respect to the third direction 352.

The fourth absolute angle Θ₄ is a positive angle with respect to the machine direction 307. The fourth absolute angle Θ₄ orients the fourth fiber segment 360 in the fourth direction 362, which has a machine direction 307 component and a cross direction 308 component. The fourth absolute angle Θ₄ is less than the third absolute angle Θ₃, such that the fourth relative angle Θ₄₋₃ is a negative angle. Due to the fourth relative angle Θ₄₋₃, the third fiber segment 350 and the fourth fiber segment 360, taken together, tend to simulate a change in the curl in the fiber 305, back toward the machine direction 307.

FIG. 3E illustrates an enlarged top view of the model 300 of FIG. 3D wherein the fiber 305 has an additional segment, which is the fifth fiber segment 370. The fifth fiber segment 370 is considered a subsequent fiber segment. For reference, FIG. 3E includes the machine direction 307 and the cross direction 308. The fifth fiber segment 370 has a first end 371 and a second end 379. The first end 371 is disposed at the second end 369 of the fourth fiber segment 360, so that the fifth fiber segment 370 is connected to the fourth fiber segment 360, end to end. The fifth fiber segment 370 has an overall length 376 and an overall width 374. The fifth fiber segment 370 is oriented in a fourth direction 372, which is at an angle of Θ₅ with respect to the machine direction 307, and at an angle of Θ₅₋₄ with respect to the fourth direction 362.

The fifth absolute angle Θ₅ is a small positive angle with respect to the machine direction 307. The fifth absolute angle Θ₅ orients the fifth fiber segment 370 in the fifth direction 372, which is oriented substantially in the machine direction 307. The fifth absolute angle Θ₅ is less than the fourth absolute angle Θ₄, such that the fifth relative angle Θ₅₋₄ is a negative angle. Due to the fifth relative angle Θ₅₋₄, the fourth fiber segment 360 and the fifth fiber segment 370, taken together, tend to simulate a further curl in the fiber 305, toward the machine direction 307.

All together, the first fiber segment 330, the second fiber segment 340, the third fiber segment 350, the fourth fiber segment 360, and the fifth fiber segment 370 create a model 300 of a portion of the fiber 305. The fiber 305 is formed by these linear segments, which are connected together, with adjacent segments angled with respect to each other. Further, additional subsequent fiber segments can be added to the model 300, as described above, until the fiber 305 is complete. Due to the relative angles between the fiber segments, the fiber 305 follows a nonlinear path in the model 300.

FIG. 3F illustrates a top view of the model 300 of FIG. 3E, with additional subsequent fiber segments. For reference, FIG. 3E includes the machine direction 307 and the cross direction 308. The marked portion of FIG. 3F corresponds with FIG. 3E. When viewed from a distance, the fiber 305 appears to have a path with an overall shape that is substantially curved. Since the overall length of each fiber segment is short, when compared with the overall length of the fiber 305, when the fiber 305 is viewed as a whole, the linearity of the fiber segments, and the angles between the fiber segments are not readily apparent, and the fiber 305 appears to have a path with an overall shape that is substantially curved.

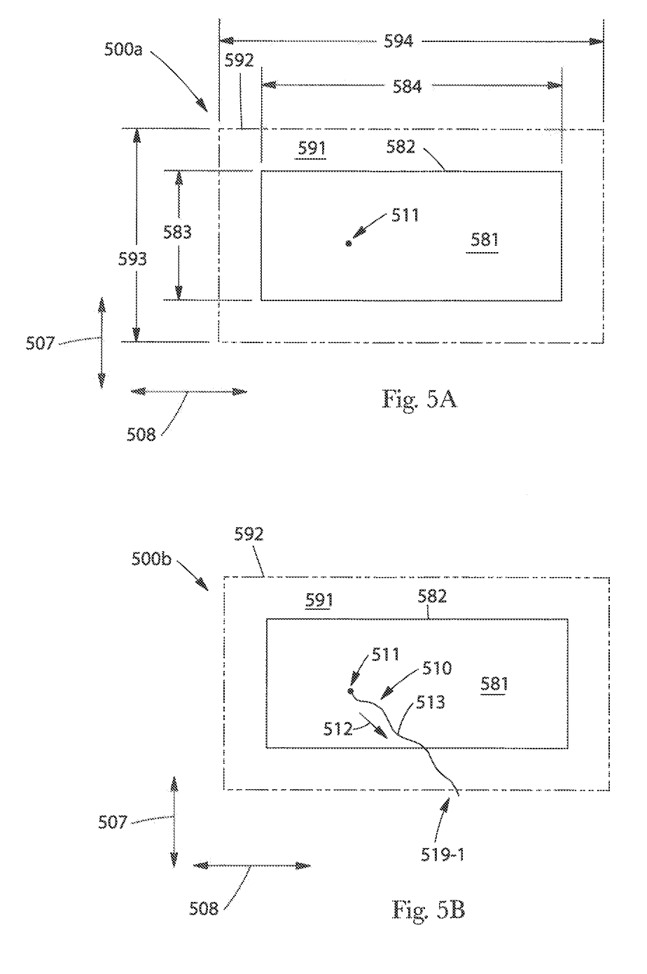

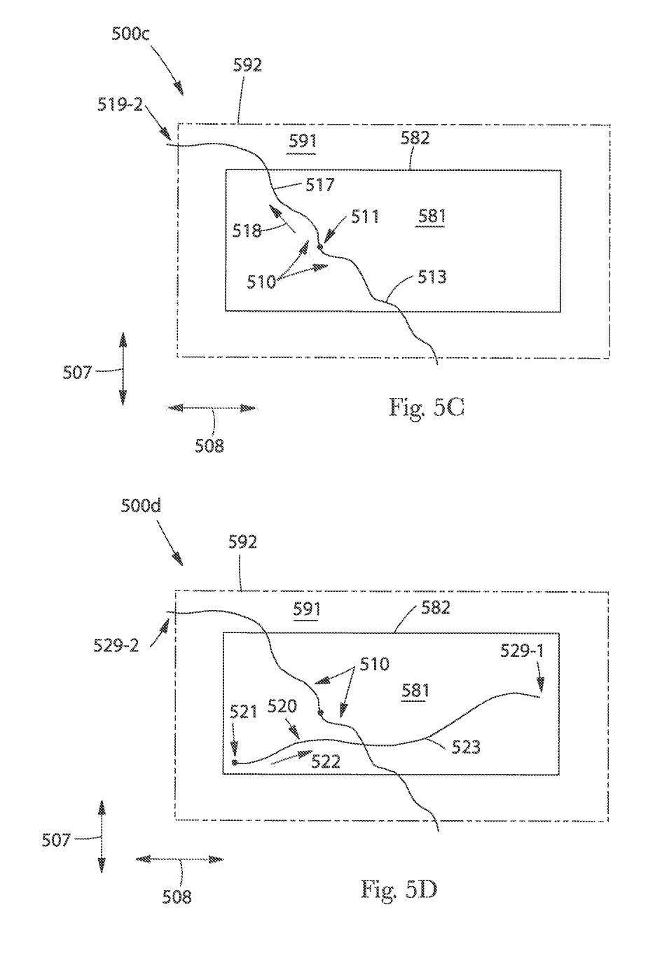

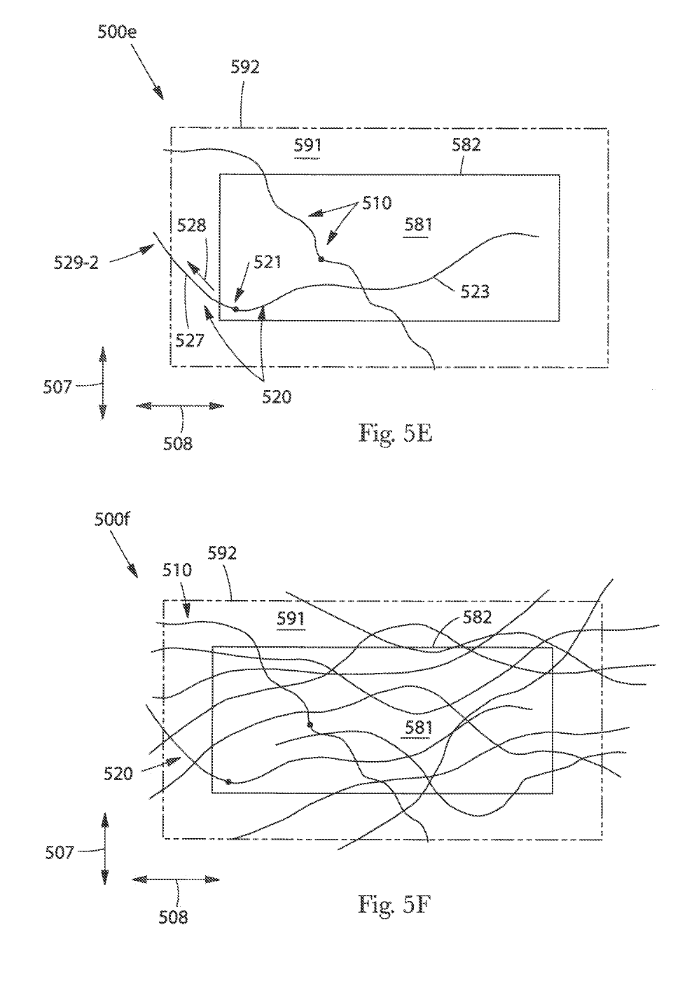

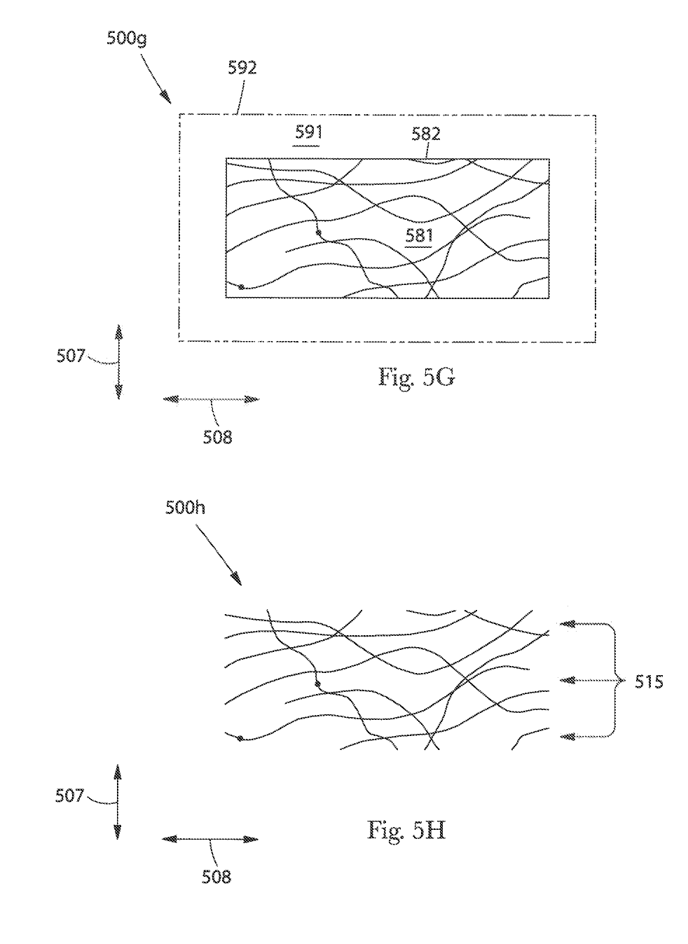

The model 300 can serve as a basis for a computer based model of a fibrous material, such as the fibrous material of the embodiment of FIGS. 5A-5H. A computer based model can represent a fibrous material with a plurality of fibers wherein at least some, or substantially all, or even all of the fibers are represented in the same way as the fiber 305 of the model 300.

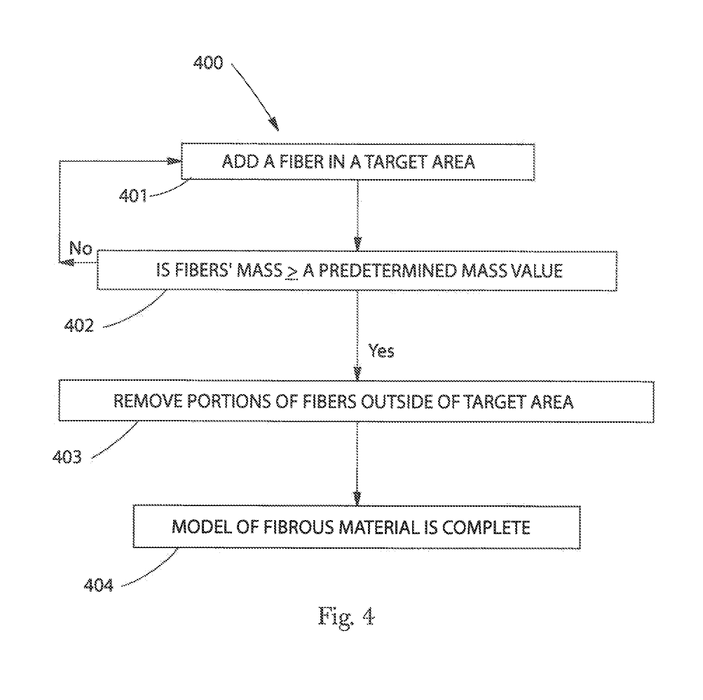

FIG. 4 illustrates a method 400 of creating a computer based model of a fibrous material. Although the steps 401-404 are described in numerical order in the present disclosure, in various embodiments some or all of these steps can be performed in other orders, and/or at overlapping times, and/or at the same time, as will be understood by one of ordinary skill in the art. Program instructions in CAE software (and/or other software) can execute to perform each step in the method 400, as described below.

The method 400 includes a first step 401 of adding a model of a fiber to a target area. The fiber can be created as described in connection with the method 100 of FIG. 1. The fiber can be added to a target area as described in connection with the embodiment of FIGS. 5A-5H. The method 400 includes a second step 402 of determining whether the mass of the fibrous material has reached a predetermined mass value. For example, the mass can be determined by using information about the density and the geometry of the fibers.

In various embodiments, the second step 402 can additionally or alternatively determine whether another property of the fibrous material has reached a predetermined value. For example, the second step 402 may determine whether the volume or fiber density of the fibrous material has reached a predetermined value.

If the mass of the fibrous material has not reached the predetermined mass value, then the method 400 proceeds to repeat the first step 401. If the mass of the fibrous material has reached the predetermined mass value, then the method 400 proceeds to the third step 403. The method 400 includes a third step 403 of removing portions of the fibers added in the first step 401. In the third step, portions of the fibers that are outside of the target area are removed as described in connection with the embodiment of FIGS. 5F and 5G. In various embodiments, the third step may be omitted. The fourth step 404 marks the completion of the model of the fibrous material.

FIGS. 5A-5H illustrates a computer based modeling environment for use in a method of creating a computer based model of a fibrous material, such as the method 400 of FIG. 4.

FIG. 5A illustrates a top view of a computer based modeling environment 500a for use in a method of creating a computer based model of a fibrous material. The computer based modeling environment 500a includes a target area 581 and an excess area 591, both lying in the same plane. For reference, FIG. 5A includes a machine direction 507 and a cross direction 508.

The target area 581 is defined by a target boundary 582 (illustrated with solid lines). The target area 581 has an overall shape that is rectangular; however, in various embodiments, a target area may have a different overall shape. For example, an overall shape of a target area can be circular, oval, elliptical, square, triangular, polygonal, or some other shape. The target area 581 has an overall length 583 in the machine direction 507, as well as an overall width 584 in the cross direction 508. The dimensions of the target area can be determined based on one or more user inputs. Program instructions in CAE software (and/or other software) can execute to define the target area, as described below.

The excess area 591 is defined by an excess boundary 592 (illustrated as double-dashed lines). The excess area 591 also has an overall shape that is rectangular, with a rectangular opening in the middle. However, in various embodiments, an excess area may have a different overall shape. For example, an overall shape of an excess area can be circular, oval, elliptical, square, triangular, polygonal, or some other shape. The excess area 591 has an overall length 593 in the machine direction 507, as well as an overall width 594 in the cross direction 508. The excess area 591 is the area defined by these overall dimensions, minus the target area 581. The dimensions of the excess area can be determined based on one or more user inputs. Program instructions in CAE software (and/or other software) can execute to define the excess area, as described below.

The overall length 593 of the excess area 591 is greater than the overall length 583 of the target area 583. The overall width 594 of the excess area 591 is greater than the overall length 584 of the target area 583. The excess area 591 extends beyond the target area 581 on all sides; however in various embodiments, an excess area may extend beyond less than all of the sides of a target area. As examples, an excess area may extend beyond part, or parts, or all of one or or two or three or more sides of a target area. The computer based modeling environment 500a also includes a fiber starting point 511, which is selected as described in step 101 of the method 100 of FIG. 1. Program instructions in CAE software (and/or other software) can execute to select the fiber starting point, as described below.

FIG. 5B illustrates a computer based modeling environment 500-B, which is the computer based modeling environment 500a at a subsequent point in the method of creating the computer based model of the fibrous material. The computer based modeling environment 500-B includes a first portion 513 of the computer based model of a first fiber 510, starting at the first fiber starting point 511 and extending in a first overall direction 512 to a first end 519-1. The first portion 513 starts as described in steps 101-102 of the method 100 of FIG. 1, extends through a portion of the target area 581, past the target boundary 582, and into the excess area 591 as described in step 103 of the method 100 of FIG. 1, then ends after crossing a side of the excess boundary 592, as described in step 104 of FIG. 1. Program instructions can execute to start, extend, and end a first portion of a fiber within a computer based modeling environment, as described above.

FIG. 5C illustrates a computer based modeling environment 500c, which is the computer based modeling environment 500-B at a subsequent point in the method of creating the computer based model of the fibrous material. The computer based modeling environment 500c includes a second portion 517 of the computer based model of the first fiber 510, starting at the first fiber starting point 511 and extending in a second overall direction 518 to a second end 519-2. The second portion 517 extends through a portion of the target area 581, past the target boundary 582, and into the excess area 591 as described in step 103 of the method 100 of FIG. 1, then ends after crossing another side of the excess boundary 592, as described in step 104 of FIG. 1. Program instructions can execute to start, extend, and end a second portion of a fiber within a computer based modeling environment, as described above.

FIG. 5D illustrates a computer based modeling environment 500d, which is the computer based modeling environment 500c at a subsequent point in the method of creating the computer based model of the fibrous material. The computer based modeling environment 500d includes a second fiber starting point 521 and a first portion 523 of a computer based model of a second fiber 520, starting at the second fiber starting point 521 and extending in a first overall direction 522 to a first end 529-1. The first portion 523 starts as described in steps 101-102 of the method 100 of FIG. 1, extends through a portion of the target area 581, then ends after reaching a predetermined length value, as described in step 105 of FIG. 1. Program instructions can execute to start, extend, and end a first portion of a fiber within a computer based modeling environment, as described above.

FIG. 5E illustrates a computer based modeling environment 500e, which is the computer based modeling environment 500d at a subsequent point in the method of creating the computer based model of the fibrous material. The computer based modeling environment 500e includes a second portion 527 of the computer based model of the second fiber 520, starting at the second fiber starting point 521 and extending in a second overall direction 528 to a second end 529-2. The second portion 527 extends through a portion of the target area 581, past the target boundary 582, and into the excess area 591 as described in step 103 of the method 100 of FIG. 1, then ends after crossing a side of the excess boundary 592, as described in step 104 of FIG. 1. Program instructions can execute to start, extend, and end a second portion of a fiber within a computer based modeling environment, as described above.

FIG. 5F illustrates a computer based modeling environment 500f, which is the computer based modeling environment 500e at a subsequent point in the method of creating the computer based model of the fibrous material. The computer based modeling environment 500f includes the model of the first fiber 510, the model of the second fiber 520, and models of additional fibers. The method of creating the computer based model of the fibrous material adds the fibers as described in step 401 of the method 400 of FIG. 4 then ends when the mass of the fibers reaches a predetermined mass value, as described in step 402 of FIG. 4. The models of the fibers in FIG. 5F, all together form a precursor to the model of the fibrous material. Alternatively, the models of the fibers in FIG. 5F may be considered the complete model of the fibrous material. Program instructions can execute to add fibers within a computer based modeling environment, as described above.

FIG. 5G illustrates a computer based modeling environment 500g, which is the computer based modeling environment 500f at a subsequent point in the method of creating the computer based model of the fibrous material. The computer based modeling environment 500g includes the model of the first fiber 510, the model of the second fiber 520, and the models of the additional fibers, with portions of the fibers removed. The portions of the fibers that are outside of the target area 581 are removed. Program instructions can execute to remove portions of fibers from a computer based modeling environment, as described above.

FIG. 5H illustrates a computer based modeling environment 500h, which is the computer based modeling environment 500g with the target boundary and the excess boundary removed, for clarity. FIG. 5H illustrates a cut edge 515 on fibrous material, which is the result of the removal of the portions of the fibers outside of the target area.

The present disclosure provides methods for modeling a fibrous web. The methods can predict a fiber's location, curliness, and orientation, while accounting for randomness and probabilities. The methods can be used to create a realistic model of a fibrous material. As a result, fibrous materials can be evaluated and modified as computer based models before they are tested as real world things. Such models can also be used to analyze existing real world things, and/or to compare existing real world things with variations and with new things.

In various embodiments, the methods of the present disclosure can be used to create realistic models of fibrous materials, which can then be transformed to create models of processed fibrous materials, as described in the US non-provisional patent application entitled “Computer Based Modeling of Processed Fibrous Materials,” filed on TBD under attorney docket number TBD, which is incorporated herein by reference. For example, the methods of the present disclosure can be used to create realistic models of fibrous materials, which are then transformed by adding bond patterns to such models of fibrous materials. In particular, models of processed fibrous materials can include models of processed fibers that account for fiber weakening, fiber strengthening, and/or fiber changes from processing, as disclosed in the patent application described above.

In particular, computer based models of fibrous materials, as described in the present disclosure, can be used in simulated testing, to determine their performance characteristics. For example, in one kind of simulated testing, various boundary conditions can be applied to a computer based model of a fibrous web, to determine the performance of the web. The model of the web can be pulled in tension, while measuring the applied forces and/or displacements as well as the stresses, strains, and deformations experienced by the web, over a period of time. These measurements can then be used to calculate various mechanical properties of the modeled web, such as its stiffness, elasticity, tensile strength, strain energy, neckdown, etc. In some embodiments, a computer based model of a fibrous material can be used in simulated testing to evaluate various geometries of the material, such as its thickness, density, porosity, etc.

A computer based model of a fibrous material can be easily varied, to determine how such variations affect the mechanical properties of the web. As an example, various fiber laydown patterns, fiber sizes, and/or material basis weights can be applied to a model of a fibrous web, to determine how theses parameters affect the performance of the web. In some embodiments, a computer based model of a fibrous material can be systematically varied in a virtual design of experiments that tests many variations of several aspects of the model. The empirical results of the virtual experiments can be statistically analyzed to determine the relationship between the variations and the mechanical properties of the web.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method comprising:
representing a fibrous material with a computer based model of the fibrous material, wherein the fibrous material includes a plurality of fibers and at least some of the fibers are nonlinear fibers;
transforming the computer based model of fibrous material, by modeling a physical behavior of at least some of the fibers to form a transformed fibrous material; and
representing the transformed fibrous material with a computer based model of the transformed fibrous material.

2. The method of claim 1, wherein the representing of the fibrous material includes representing the fibrous material with the computer based model of the fibrous material, wherein each of the nonlinear fibers has a path with an overall shape that is substantially curved.

3. The method of claim 1, wherein the representing of the fibrous material includes representing the fibrous material with the computer based model of the fibrous material, wherein each of the nonlinear fibers includes a series of connected linear segments, the connected linear segments includes angled linear segments, and the angled linear segments that are adjacent to each other are angled with respect to each other.

4. The method of claim 3, including determining a particular upper length value based, at least in part, on the spacing of bond sites in a nonwoven bond pattern;
wherein the representing of the fibrous material includes representing the fibrous material with the computer based model of the fibrous material, wherein each of the linear segments has a segment length that is less than or equal to the particular upper length value.

5. The method of claim 3, wherein the representing of the fibrous material includes representing the fibrous material with the computer based model of the fibrous material, wherein each of the angled linear segments that are adjacent to each other are angled with respect to each other, with an angle based, at least in part, on a particular curl factor.

6. The method of claim 1, wherein the representing of the fibrous material includes representing the fibrous material with the computer based model of the fibrous material, wherein the fibrous material has a machine direction and a cross direction, and the nonlinear fibers are oriented in the machine direction and the cross direction based, at least in part, on a particular angle orientation factor.

7. The method of claim 1, wherein the representing of the fibrous material includes representing the fibrous material with the computer based model of the fibrous material, wherein the fibrous material has an outer edge and at least a portion of the outer edge is a cut edge.

8. A computer readable medium having instructions for causing a device to perform a method, the method comprising:
representing a fibrous material with a computer based model of the fibrous material, wherein the fibrous material includes a plurality of fibers and at least some of the fibers are nonlinear fibers;
transforming the computer based model of fibrous material, by modeling a physical behavior of at least some of the fibers to form a transformed fibrous material; and
representing the transformed fibrous material with a computer based model of the transformed fibrous material.

9. A method comprising:
representing a fibrous material with a computer based model of the fibrous material, including generating a plurality of fibers over a target area and over an excess area that extends beyond the target area, and for at least some of the fibers, removing a portion of the fiber that is outside of the target area, wherein the fibrous material includes the portions of the fibers disposed within the target area;
transforming the computer based model of fibrous material, by modeling a physical behavior of at least some of the fibers to form a transformed fibrous material; and
representing the transformed fibrous material with a computer based model of the transformed fibrous material.

10. The method of claim 9, wherein the representing of the fibrous material includes generating a plurality of fibers over an excess area that extends beyond all sides of the target area.

11. The method of claim 9, wherein the representing of the fibrous material includes generating a plurality of fibers over a rectangular target area.

12. A computer readable medium having instructions for causing a device to perform a method, the method comprising
representing a fibrous material with a computer based model of the fibrous material, including generating a plurality of fibers over a target area and over an excess area that extends beyond the target area, and for at least some of the fibers, removing a portion of the fiber that is outside of the target area, wherein the fibrous material includes the portions of the fibers disposed within the target area;
transforming the computer based model of fibrous material, by modeling a physical behavior of at least some of the fibers to form a transformed fibrous material; and
representing the transformed fibrous material with a computer based model of the transformed fibrous material.

13. A method comprising:
representing a fibrous material with a computer based model of the fibrous material, including generating a plurality of fibers, wherein each of the fibers is disposed at a randomly selected starting point, and the fibrous material includes the fibers;
transforming the computer based model of fibrous material, by modeling a physical behavior of at least some of the fibers to form a transformed fibrous material; and
representing the transformed fibrous material with a computer based model of the transformed fibrous material.

14. The method of claim 13, wherein the representing of the fibrous material includes generating the plurality of fibers, wherein at least a portion of each of the fibers is generated by connecting a plurality of angled linear segments in series and angling adjacent angled linear segments with respect to each other.

15. The method of claim 14, wherein the representing of the fibrous material includes generating the plurality of fibers, wherein the angling is based on a stochastic process.

16. The method of claim 14, wherein the representing of the fibrous material includes generating the plurality of fibers, wherein the angling is based, at least in part on a curl factor.

17. The method of claim 14, wherein the representing of the fibrous material includes generating the plurality of fibers, wherein the angling is based, at least in part on an angle orientation factor.

18. The method of claim 14, wherein the representing of the fibrous material includes generating the plurality of fibers, wherein the angling of each subsequent segment is based, at least in part on the angling of a prior segment.

19. The method of claim 14, wherein the representing of the fibrous material includes generating the plurality of fibers, wherein the angling includes an initial angling based, at least in part on an initial angle orientation factor.

20. The method of claim 19, wherein the representing of the fibrous material includes generating the plurality of fibers, wherein the angling includes an initial angling based, at least in part on an initial angle randomly selected from a probability distribution that is based, at least in part, on the initial angle orientation factor.
